(19) United States
(12) Patent Application Publication
(10) Pub. No.: US 2014/0085576 A1
(43) Pub. Date: Mar. 27, 2014

(54) Light Guide Plates and Optical Films with Mating Alignment Features

(71) Applicant: APPLE INC., Cupertino, CA (US)

(72) Inventors: Eric Benson, San Francisco, CA (US); Adam T. Garelli, Santa Clara, CA (US); Dinesh C. Mathew, Fremont, CA (US); Bryan W. Posner, La Selva Beach, CA (US); Jun Qi, Cupertino, CA (US); Victor H. Yin, Cupertino, CA (US)

(73) Assignee: Apple Inc., Cupertino, CA (US)

(21) Appl. No.: 13/629,440

(22) Filed: Sep. 27, 2012

(51) Int. Cl. G02F 1/1335; F21V 17/02

(52) U.S. Cl. 349/106; 362/618

(57) ABSTRACT

Electronic devices may be provided with backlight structures that provide backlight illumination for a display. The backlight structures include a light source such as an array of light-emitting diodes that launches light into an edge of a light guide plate. The light guide plate distributes the light laterally across display layers in the display. One or more optical films such as brightness enhancement films and diffuser layers are interposed between the display layers and the light guide plate. The light guide plate includes light guide plate alignment features that mate with corresponding optical film alignment features in the optical films. The light guide plate alignment features may be protrusions that extend into openings such as notches or holes in the optical films. The light guide plate may have a protruding portion that extends around a periphery of the light guide plate and surrounds a perimeter of the optical films.

### BACKGROUND

This relates generally to electronic devices and, more particularly, to electronic devices with displays.

Electronic devices often include displays. For example, cellular telephones and portable computers often include displays for presenting information to a user. An electronic device may have a housing such as a housing formed from plastic or metal. Components for the electronic device such as display components may be mounted in the housing.

It can be challenging to incorporate a display into the housing of an electronic device. Size and weight are often important considerations in designing electronic devices. If care is not taken, displays may be bulky or may be surrounded by overly large borders. The housing of an electronic device can be adjusted to accommodate a bulky display with large borders, but this can lead to undesirable enlargement of the size and weight of the housing and unappealing device aesthetics.

It would therefore be desirable to be able to provide improved ways to provide displays for electronic devices.

### SUMMARY

An electronic device may be provided with a display. The display includes display layers for displaying images. The display also includes backlight structures that provide backlight illumination to the display layers.

The display backlight structures include a light source such as an array of light-emitting diodes. Light from the light source is coupled into an edge of a light guide plate. The light guide plate distributes the backlight laterally across the display layers.

One or more optical films such as brightness enhancement films and diffuser layers are interposed between the display layers and the light guide plate.

The optical films include optical film alignment features that are configured to mate with corresponding light guide plate alignment features on the light guide plate. The mating alignment features are used to align the optical films with respect to the light guide plate.

The optical film alignment features may include openings such as notches or holes. The openings may be formed at opposing edges of the optical films. The light guide plate alignment features may include protrusions that each extend into a respective opening in the optical films. Portions of the optical films may partially or completely surround the light guide plate protrusions.

If desired, the light guide plate may have a protruding portion that extends around the entire periphery of the light guide plate. With this type of configuration, the protruding portion of the light guide plate completely surrounds a perimeter of the optical films. The protruding portion laterally aligns the optical films with respect to the light guide plate and helps protect the optical films from moisture and other contaminants.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device such as a laptop computer with a display in accordance with an embodiment.

FIG. 2 is a perspective view of an illustrative electronic device such as a handheld electronic device with a display in accordance with an embodiment.

FIG. 3 is a perspective view of an illustrative electronic device such as a tablet computer with a display in accordance with an embodiment.

FIG. 4 is a schematic diagram of an illustrative electronic device with a display in accordance with an embodiment.

FIG. 5 is a cross-sectional side view of an illustrative display in accordance with an embodiment.

FIG. 6 is a cross-sectional side view of an illustrative display having optical films and a light guide plate with mating alignment features in accordance with an embodiment.

FIG. 7 is top view of an illustrative arrangement in which protruding alignment structures on a light guide plate mate with corresponding notches in a stack of optical films in accordance with an embodiment.

FIG. 8 is a top view of an illustrative arrangement in which protruding alignment structures on a light guide plate mate with corresponding holes in a stack of optical films in accordance with an embodiment.

FIG. 9 is a top view of an illustrative arrangement in which protruding alignment structures on a light guide plate mate with corresponding holes in a stack of optical films in accordance with an embodiment.

FIG. 10 is an exploded perspective view of an illustrative arrangement in which a light guide plate alignment feature is formed along the entire periphery of the light guide plate to form a recess in which a stack of optical films is placed in accordance with an embodiment.

FIG. 11 is a diagram showing how a molding tool molds polymer material into a light guide plate having alignment features and showing how the light guide plate and additional device parts such as a housing are assembled to form a finished electronic device in accordance with an embodiment.

FIG. 12 is a diagram showing how a molding tool performs a two-step molding process to mold polymer material into a light guide plate having alignment features and showing how the light guide plate and additional device parts such as a housing are assembled to form a finished electronic device in accordance with an embodiment.

### DETAILED DESCRIPTION

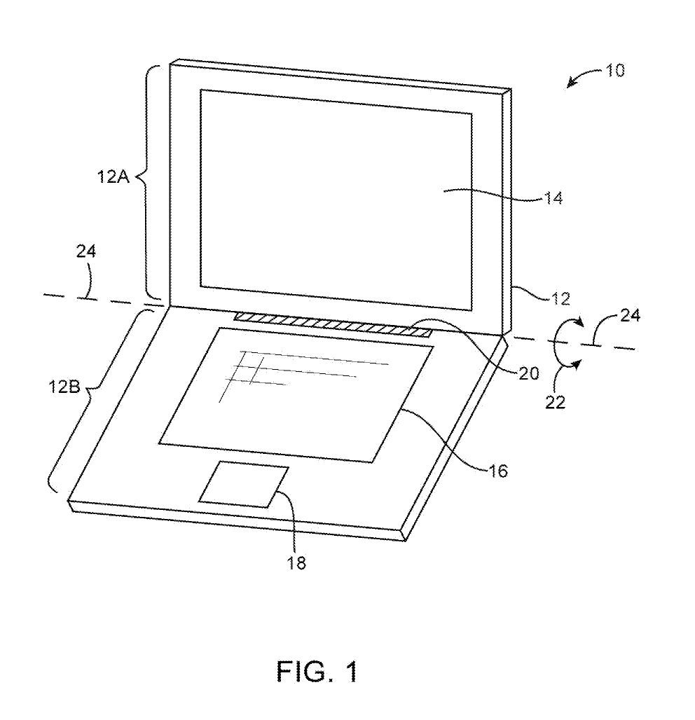

Electronic devices may include displays. The displays may be used to display images to a user. Illustrative electronic devices that may be provided with displays are shown in FIGS. 1, 2, and 3.

FIG. 1 shows how electronic device 10 may have the shape of a laptop computer having upper housing 12A and lower housing 12B with components such as keyboard 16 and touchpad 18. Device 10 may have hinge structures 20 that allow upper housing 12A to rotate in directions 22 about rotational axis 24 relative to lower housing 12B. Display 14 may be mounted in upper housing 12A. Upper housing 12A, which may sometimes referred to as a display housing or lid, may be placed in a closed position by rotating upper housing 12A towards lower housing 12B about rotational axis 24.

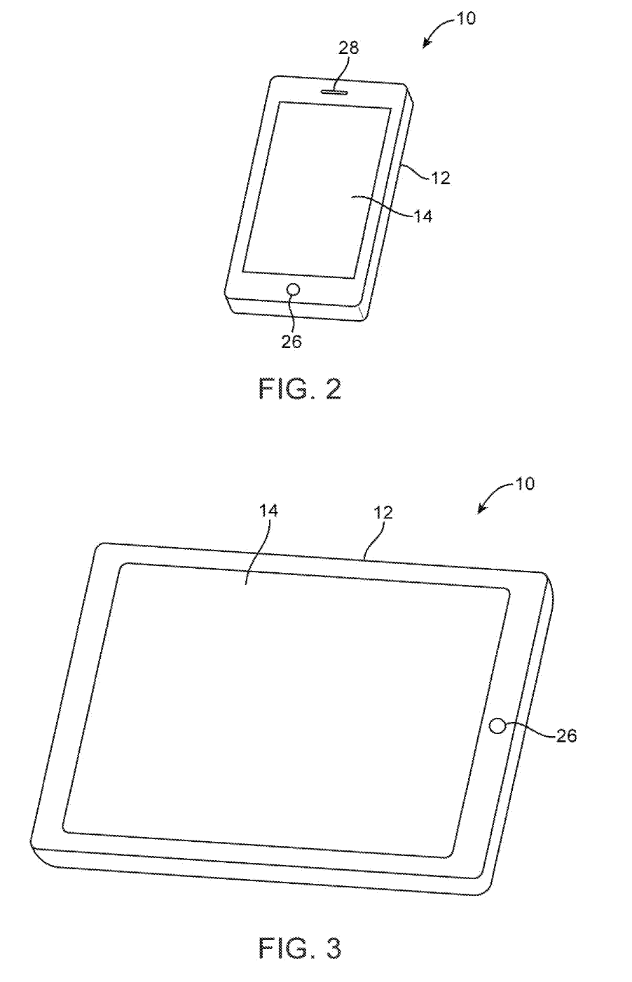

FIG. 2 shows how electronic device 10 may be a handheld device such as a cellular telephone, music player, gaming device, navigation unit, or other compact device. In this type of configuration for device 10, housing 12 may have opposing front and rear surfaces. Display 14 may be mounted on a front face of housing 12. Display 14 may, if desired, have a display cover layer or other exterior layer that includes openings for components such as button 26. Openings may also be formed in a display cover layer or other display layer to accommodate a speaker port (see, e.g., speaker port 28 of FIG. 2).

FIG. 3 shows how electronic device 10 may be a tablet computer. In electronic device 10 of FIG. 3, housing 12 may have opposing planar front and rear surfaces. Display 14 may be mounted on the front surface of housing 12. As shown in FIG. 3, display 14 may have a cover layer or other external layer with an opening to accommodate button 26 (as an example).

The illustrative configurations for device 10 that are shown in FIGS. 1, 2, and 3 are merely illustrative. In general, electronic device 10 may be a laptop computer, a computer monitor containing an embedded computer, a tablet computer, a cellular telephone, a media player, or other handheld or portable electronic device, a smaller device such as a wrist-watch device, a pendant device, a headphone or earpiece device, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment.

Housing 12 of device 10, which is sometimes referred to as a case, may be formed of materials such as plastic, glass, ceramics, carbon-fiber composites and other fiber-based composites, metal (e.g., machined aluminum, stainless steel, or other metals), other materials, or a combination of these materials. Device 10 may be formed using a unibody construction in which most or all of housing 12 is formed from a single structural element (e.g., a piece of machined metal or a piece of molded plastic) or may be formed from multiple housing structures (e.g., outer housing structures that have been mounted to internal frame elements or other internal housing structures).

Display 14 may be a touch sensitive display that includes a touch sensor or may be insensitive to touch. Touch sensors for display 14 may be formed from an array of capacitive touch sensor electrodes, a resistive touch array, touch sensor structures based on acoustic touch, optical touch, or force-based touch technologies, or other suitable touch sensor components.

Displays for device 10 may, in general, include image pixels formed from light-emitting diodes (LEDs), organic LEDs (OLEDs), plasma cells, electrowetting pixels, electrophoretic pixels, liquid crystal display (LCD) components, or other suitable image pixel structures. In some situations, it may be desirable to use LCD components to form display 14, so configurations for display 14 in which display 14 is a liquid crystal display are sometimes described herein as an example. It may also be desirable to provide displays such as display 14 with backlight structures, so configurations for display 14 that include a backlight unit may sometimes be described herein as an example. Other types of display technology may be used in device 10 if desired. The use of liquid crystal display structures and backlight structures in device 10 is merely illustrative.

A display cover layer may cover the surface of display 14 or a display layer such as a color filter layer or other portion of a display may be used as the outermost (or nearly outermost) layer in display 14. A display cover layer or other outer display layer may be formed from a transparent glass sheet, a clear plastic layer, or other transparent member.

Touch sensor components such as an array of capacitive touch sensor electrodes formed from transparent materials such as indium tin oxide may be formed on the underside of a display cover layer, may be formed on a separate display layer such as a glass or polymer touch sensor substrate, or may be integrated into other display layers (e.g., substrate layers such as a thin-film transistor layer).

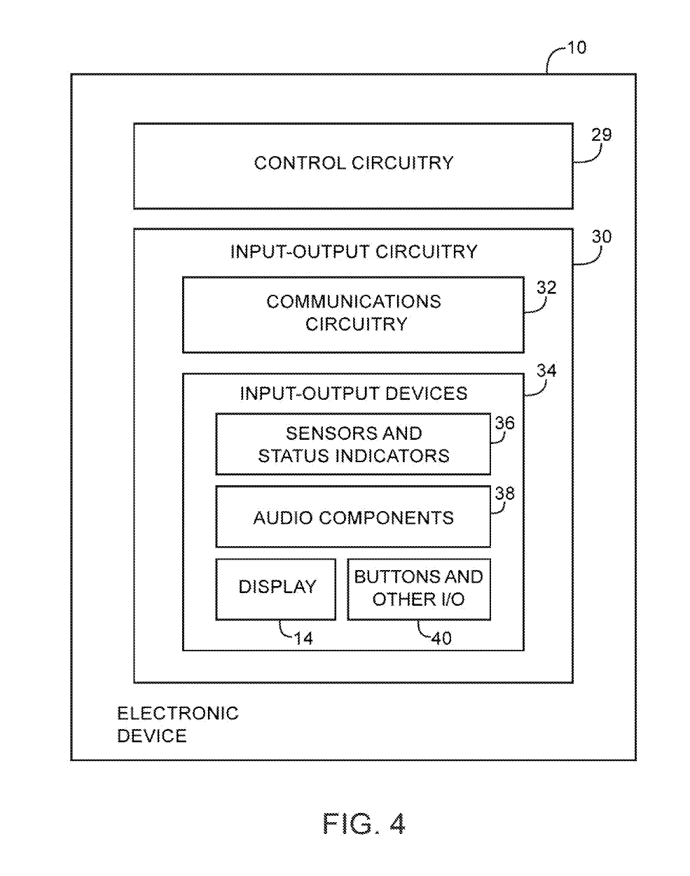

A schematic diagram of an illustrative configuration that may be used for electronic device 10 is shown in FIG. 4. As shown in FIG. 4, electronic device 10 may include control circuitry 29. Control circuitry 29 may include storage and processing circuitry for controlling the operation of device 10. Control circuitry 29 may, for example, include storage such as hard disk drive storage, nonvolatile memory (e.g., flash memory or other electrically-programmable-read-only memory configured to form a solid state drive), volatile memory (e.g., static or dynamic random-access-memory), etc. Control circuitry 29 may include processing circuitry based on one or more microprocessors, microcontrollers, digital signal processors, baseband processors, power management units, audio codec chips, application specific integrated circuits, etc.

Control circuitry 29 may be used to run software on device 10, such as operating system software and application software. Using this software, control circuitry 29 may present information to a user of electronic device 10 on display 14. When presenting information to a user on display 14, sensor signals and other information may be used by control circuitry 29 in making adjustments to the strength of backlight illumination that is used for display 14.

Input-output circuitry 30 may be used to allow data to be supplied to device 10 and to allow data to be provided from device 10 to external devices. Input-output circuitry 30 may include communications circuitry 32. Communications circuitry 32 may include wired communications circuitry for supporting communications using data ports in device 10. Communications circuitry 32 may also include wireless communications circuits (e.g., circuitry for transmitting and receiving wireless radio-frequency signals using antennas).

Input-output circuitry 30 may also include input-output devices 34. A user can control the operation of device 10 by supplying commands through input-output devices 34 and may receive status information and other output from device 10 using the output resources of input-output devices 34.

Input-output devices 34 may include sensors and status indicators 36 such as an ambient light sensor, a proximity sensor, a temperature sensor, a pressure sensor, a magnetic sensor, an accelerometer, and light-emitting diodes and other components for gathering information about the environment in which device 10 is operating and providing information to a user of device 10 about the status of device 10.

Audio components 38 may include speakers and tone generators for presenting sound to a user of device 10 and microphones for gathering user audio input.

Display 14 may be used to present images for a user such as text, video, and still images. Sensors 36 may include a touch sensor array that is formed as one of the layers in display 14.

User input may be gathered using buttons and other input-output components 40 such as touch pad sensors, buttons, joysticks, click wheels, scrolling wheels, touch sensors such as sensors 36 in display 14, key pads, keyboards, vibrators, cameras, and other input-output components.

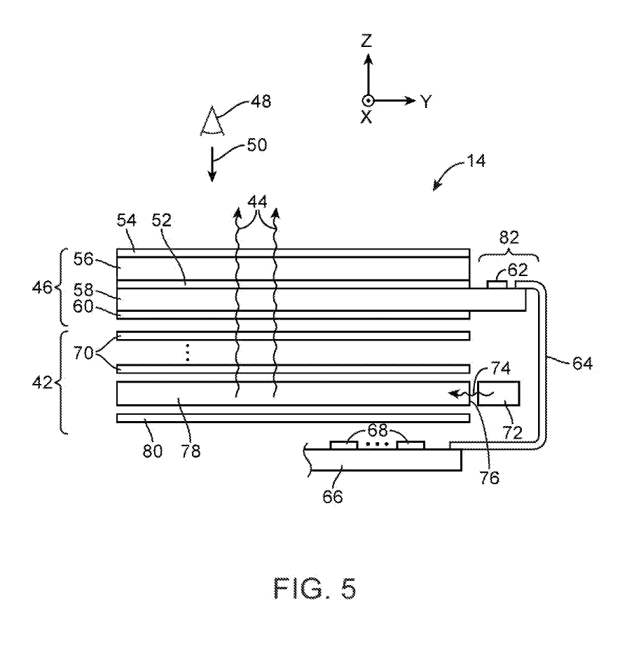

A cross-sectional side view of an illustrative configuration that may be used for display 14 of device 10 (e.g., for display 14 of the devices of FIG. 1, FIG. 2, or FIG. 3 or other suitable electronic devices) is shown in FIG. 5. As shown in FIG. 5, display 14 may include backlight structures such as backlight unit 42 for producing backlight 44. During operation, backlight 44 travels outwards (vertically upwards in dimension Z in the orientation of FIG. 5) and passes through display pixel structures in display layers 46. This illuminates any images that are being produced by the display pixels for viewing by a user. For example, backlight 44 may illuminate images on display layers 46 that are being viewed by viewer 48 in direction 50.

Display layers 46 may be mounted in chassis structures such as a plastic chassis structure and/or a metal chassis structure to form a display module for mounting in housing 12 or display layers 46 may be mounted directly in housing 12 (e.g., by stacking display layers 46 into a recessed portion in housing 12). Display layers 46 may form a liquid crystal display or may be used in forming displays of other types.

In a configuration in which display layers 46 are used in forming a liquid crystal display, display layers 46 may include a liquid crystal layer such a liquid crystal layer 52. Liquid crystal layer 52 may be sandwiched between display layers such as display layers 58 and 56. Layers 56 and 58 may be interposed between lower polarizer layer 60 and upper polarizer layer 54.

Layers 58 and 56 may be formed from transparent substrate layers such as clear layers of glass or plastic. Layers 56 and 58 may be layers such as a thin-film transistor layer and/or a color filter layer. Conductive traces, color filter elements, transistors, and other circuits and structures may be formed on the substrates of layers 58 and 56 (e.g., to form a thin-film transistor layer and/or a color filter layer). Touch sensor electrodes may also be incorporated into layers such as layers 58 and 56 and/or touch sensor electrodes may be formed on other substrates.

With one illustrative configuration, layer 58 may be a thin-film transistor layer that includes an array of thin-film transistors and associated electrodes (display pixel electrodes) for applying electric fields to liquid crystal layer 52 and thereby displaying images on display 14. Layer 56 may be a color filter layer that includes an array of color filter elements for providing display 14 with the ability to display color images. If desired, layer 58 may be a color filter layer and layer 56 may be a thin-film transistor layer.

During operation of display 14 in device 10, control circuitry 29 (e.g., one or more integrated circuits such as components 68 on printed circuit 66 of FIG. 5) may be used to generate information to be displayed on display 14 (e.g., display data). The information to be displayed may be conveyed from circuitry 68 to display driver integrated circuit 62 using a signal path such as a signal path formed from conductive metal traces in flexible printed circuit 64 (as an example).

Display driver integrated circuit 62 may be mounted on thin-film-transistor layer driver ledge 82 or elsewhere in device 10. A flexible printed circuit cable such as flexible printed circuit 64 may be used in routing signals between printed circuit 66 and thin-film-transistor layer 58. If desired, display driver integrated circuit 62 may be mounted on printed circuit 66 or flexible printed circuit 64. Printed circuit 66 may be formed from a rigid printed circuit board (e.g., a layer of fiberglass-filled epoxy) or a flexible printed circuit (e.g., a flexible sheet of polyimide or other flexible polymer layer).

Backlight structures 42 may include a light guide plate such as light guide plate 78. Light guide plate 78 may be formed from a transparent material such as clear glass or plastic. During operation of backlight structures 42, a light source such as light source 72 may generate light 74. Light source 72 may be, for example, an array of light-emitting diodes.

Light 74 from light source 72 may be coupled into edge surface 76 of light guide plate 78 and may be distributed in dimensions X and Y throughout light guide plate 78 due to the principal of total internal reflection. Light guide plate 78 may include light-scattering features such as pits or bumps. The light-scattering features may be located on an upper surface and/or on an opposing lower surface of light guide plate 78.

Light 74 that scatters upwards in direction Z from light guide plate 78 may serve as backlight 44 for display 14. Light 74 that scatters downwards may be reflected back in the upwards direction by reflector 80. Reflector 80 may be formed from a reflective material such as a layer of white plastic or other shiny materials.

To enhance backlight performance for backlight structures 42, backlight structures 42 may include optical films 70. Optical films 70 may include diffuser layers for helping to homogenize backlight 44 and thereby reduce hotspots, compensation films for enhancing off-axis viewing, and brightness enhancement films (also sometimes referred to as turning films) for collimating backlight 44. Optical films 70 may overlap the other structures in backlight unit 42 such as light guide plate 78 and reflector 80. For example, if light guide plate 78 has a rectangular footprint in the X-Y plane of FIG. 5, optical films 70 and reflector 80 may have a matching rectangular footprint.

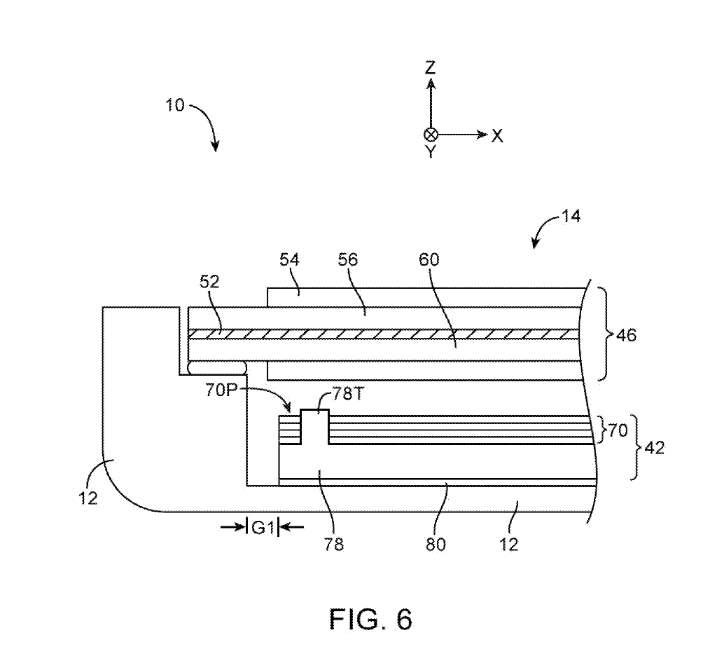

Light guide plate 78 may have a rectangular footprint when viewed in direction 50 of FIG. 5. With this type of configuration, light guide plate 78 may have a rectangular periphery with four straight edges. As shown in FIG. 6, light guide plate 78 may be mounted in housing 12 so that there is a gap G1 between at least some of the outermost edges of light guide plate 78 and the opposing inner edges of housing 12. The use of a non-zero gap G1 along the edges of light guide plate 78 can help accommodate differences in the rate of expansion between light guide plate 78 and housing 12 in lateral dimensions X and Y as device 10 is subjected to changes in temperature during operation.

It may be desirable to operate device 10 over a range of operating temperatures from a low operating temperature of T1 to a high operating temperature of T2. The value of T1 may be, for example, 0° C., −30° C., −10° C., etc. The value of T2 may be, for example, 100° C., 90° C., or 60° C., etc. With one suitable arrangement, the temperature range over which device 10 is designed to operate satisfactorily may be −20° C. to 85° C. (as an example). When operating over a range of temperatures (e.g., over a range of temperatures spanning 50° C. or more, 80° C. or more, or 100° C. or more), housing 12 and the layers in display 14 may expand and contract.

Housing 12 and the structures in display 14 may have different rates of thermal expansion. As examples, housing 12 may be formed from metal such as aluminum, which has a coefficient of thermal expansion (CTE) value of about 20 ppm. Light guide plate 78 may be formed from polymer such as polymethyl methacrylate, which has a CTE value of about 65 ppm.

Other backlight structures such as optical films 70 may also expand or contract at different rates than housing 12. For example, optical films 70 may have a coefficient of thermal expansion that exceeds that of housing 12.

In conventional electronic devices, optical films are sometimes coupled directly to the housing of the electronic device. In some situations, the optical films include tabs having holes that receive portions of the housing. In other situations, the optical films include tabs that protrude into recesses in the housing. Because the optical films expand at a faster rate than the housing, the optical film tabs adjacent to the housing run the risk of contacting the inner edges of the housing at higher temperatures, thereby potentially damaging the optical films and the display. Some devices include an air gap to help avoid this type of failure, but excessive gap size can lead to undesirable increases in the size of a device.

To help minimize the air gaps between housing 12 and backlight structures 42 and thereby implement display 14 and device 10 in a compact arrangement, light guide plate 78 may be used to laterally align optical films 70 with respect to light guide plate 78. For example, light guide plate 78 may include alignment features such as light guide plate alignment features 78T. Light guide plate alignment features 78T may be configured to mate with corresponding alignment features in optical films 70 such as optical film alignment features 70P. In the example of FIG. 6, light guide plate alignment features 78T include protrusions that extend through optical films 70 via light guide plate receiving portions 70P. Light guide plate receiving portions 70P (sometimes referred to as optical film alignment features) may include openings such as recesses, notches, holes, through-holes, or other suitable features that are configured to receive protruding portions 78T of light guide plate 78.

The example of FIG. 6 in which light guide plate alignment features 78T include protrusions and in which optical film alignment features 70P include openings that receive the protrusions is merely illustrative. If desired, optical film alignment features 70P may include protrusions (e.g., bumps or other protruding structures) and light guide plate alignment features 78T may include recesses that receive the optical film protrusions. If desired, light guide plate alignment features 78T may include a combination of protrusions and recesses and optical film alignment features 70P may include a corresponding combination of recesses and protrusions that respectively mate with light guide plate alignment features 78T.

Optical films 70 may be formed from materials that have a first coefficient of thermal expansion (CTE) such as CTE1, whereas light guide plate 78 may have a second coefficient of thermal expansion CTE2. CTE1 of optical films 70 may, for example, be less than CTE2 of light guide plate 78. With this type of arrangement, gaps between optical films 70 and light guide plate 78 may be minimized and the risk of damaging optical films 70 may be reduced. This is, however, merely illustrative. If desired, CTE1 of optical films 70 and light guide plate 78 may be configured to exhibit coefficients of thermal expansion that do not differ significantly (e.g., such that CTE2 is within 100% of CTE1, within 70% of CTE1, within 50% of CTE1, within 30% of CTE1, within 20% of CTE1, within 10% of CTE1, within 5% of CTE1, or within 1% of CTE1).

In configurations in which the coefficient of thermal expansion of optical films 70 and light guide plate 78 are closely matched, optical films 70 and light guide plate 78 will exhibit comparable changes in size (e.g., in the X-Y plane that lies parallel to the other layers of display 14). By exhibiting comparable changes in size with changes in temperature, situations can be avoided in which optical films 70 are forced against light guide plate 78 sufficiently to cause damage.

As shown in FIG. 6, light guide plate alignment features 78T (sometimes referred to as alignment structures, protrusions, or protruding portions) extend upwards in the Z direction and help align optical films 70 in the X-Y plane with respect to light guide plate 78. Using light guide plate 78 as opposed to housing 12 to laterally align optical films 70 may allow for a compact arrangement in which less space is required to accommodate thermal expansion of optical films 70.

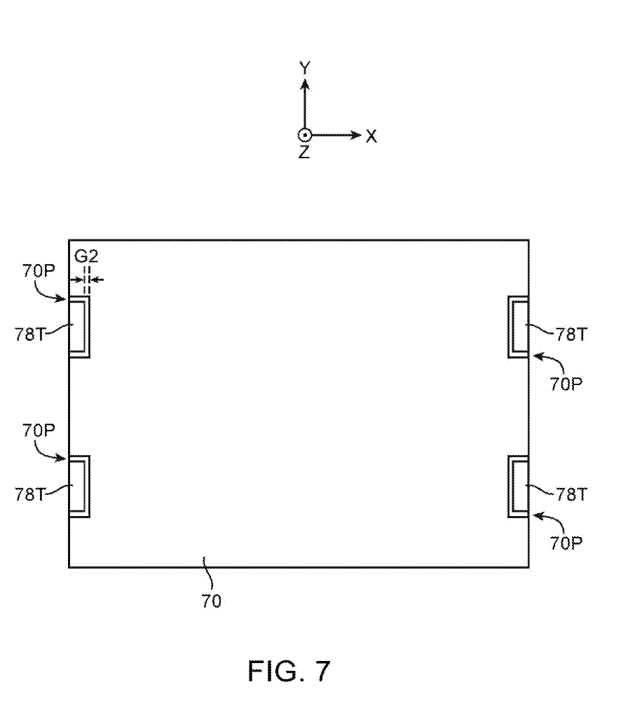

FIG. 7 is a top view of optical films 70 and light guide plate 78 showing how light guide plate alignment features 78T align optical films 70 in the X-Y plane. In the example of FIG. 7, two alignment structures 78T protrude in the Z direction on each of first and second opposing ends of light guide plate 78. Each alignment structure 78T extends through an associated optical film alignment feature 70P of optical films 70. Optical film alignment features 70P may be openings such as notches formed in opposing edges of optical films 70. Each light guide plate alignment structure 78T may be surrounded or partially surrounded by portions of optical films 70. As shown in the example of FIG. 7, a portion of optical films 70 surrounds a corresponding light guide plate alignment structure 78T on three sides.

If desired, light guide plate alignment structures 78T may be formed on one side of optical films 70, on two sides of optical films 70, on three sides of optical films 70, or on all four sides of optical films 70. There may be one, two, three or more than three light guide plate alignment structures 78T on a given side of optical films 70. The example of FIG. 7 in which two light guide plate alignment structures 78T are formed on each of two sides of optical films 70 is merely illustrative.

Light guide plate alignment structures 78T are formed from the same material that light guide plate 78 is formed from (e.g., a polymer such as polymethyl methacrylate). Light guide plate alignment structures 78T may be molded as integral parts of light guide plate 78 (e.g., using an injection molding process such as insert molding or overmolding).

In the example of FIG. 7, optical film alignment features 70P and light guide plate alignment structures 78T have rectilinear shapes. This is, however, merely illustrative. In general, optical film alignment features 70P and light guide plate alignment structures 78T may have any suitable shape (e.g., a rounded shape, a circular shape, a triangular shape, other suitable shape, etc.).

Because optical films 70 have a lower coefficient of thermal expansion than light guide plate 78, gaps G2 between optical films 70 and light guide plate alignment structures 78T may be minimized and damage to optical films 70 may be avoided.

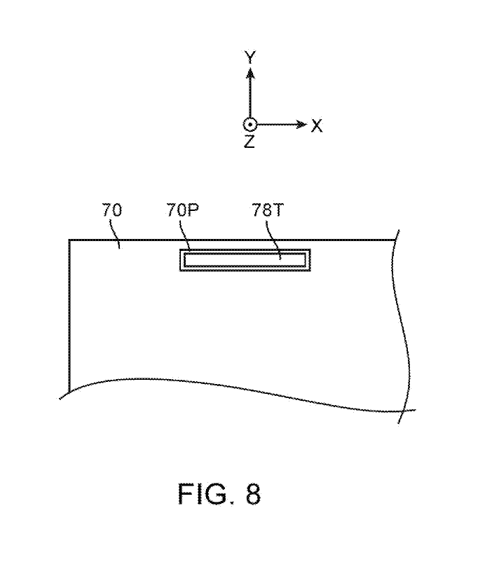

FIG. 8 is a top view of another suitable embodiment in which light guide plate 78 aligns optical films 70 in the X-Y plane with respect to light guide plate 78. In the example of FIG. 8, the perimeter of each light guide plate alignment structure 78T is completely surrounded by portions of optical films 70. Optical film alignment features 70P include holes that receive protruding portions 78T of light guide plate 78. Because portions of optical films 70 surround each alignment structure 78T, optical films 70 may be aligned in the X-Y plane with respect to light guide plate 78.

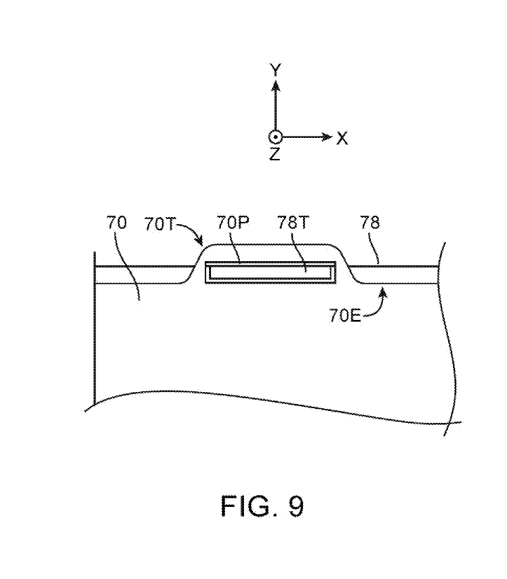

FIG. 9 is a top view of another suitable embodiment in which light guide plate 78 aligns optical films 70 in the X-Y plane with respect to light guide plate 78. In the example of FIG. 9, optical films 70 include lateral tabs such as tabs 70T. Optical film tabs 70T include portions of the optical films that extend out laterally (e.g., in the X-Y plane) from the edges of optical films 70. As shown in FIG. 9, optical film tab 70T protrudes from edge 70E in the X-Y plane.

Each optical film tab 70T includes a corresponding optical film alignment feature 70P. As shown in FIG. 9, optical film tab 70T includes an optical film alignment feature 70P such as a hole that receives protruding portion 78T of light guide plate 78. By inserting light guide plate alignment structures 78T into openings 70P in optical films 70, light guide plate 78 aligns optical films 70 in X-Y plane with respect to light guide plate 78.

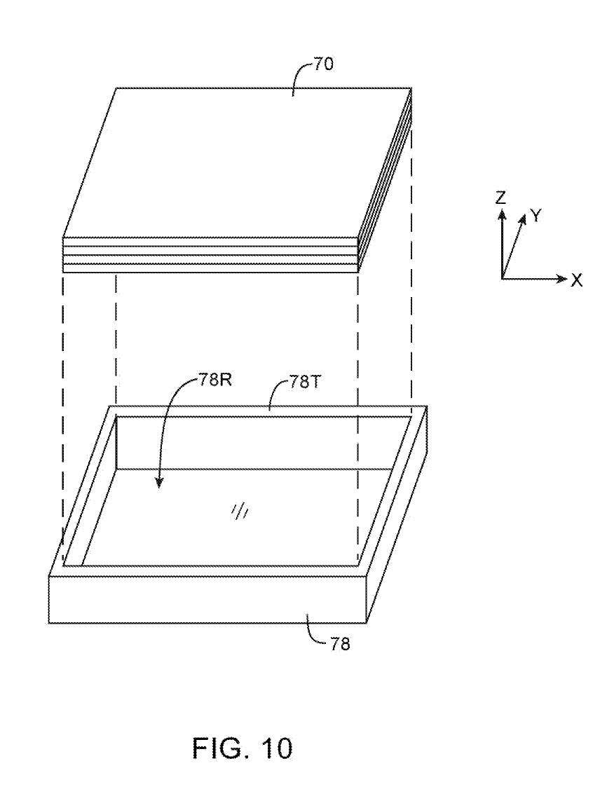

FIG. 10 is an exploded perspective view of another suitable embodiment in which light guide plate 78 aligns optical films 70 in the X-Y plane. In the example of FIG. 10, light guide plate alignment structure 78T extends around the entire periphery of light guide plate 78, thereby forming a rectangular recess such as rectangular recess 78R that receives optical film stack 70. When optical films 70 are placed within recess 78R, optical films 70 are surrounded on all four sides by light guide plate alignment structure 78T (e.g., light guide plate alignment structure 78T forms a “fence” that surrounds the full perimeter of optical films 70).

With this type of configuration, light guide plate 78 aligns optical films 70 in the X-Y plane with respect to light guide plate 78. Light guide plate fence portion 78T also forms a barrier around optical films 70 that helps protect optical films 70 from moisture and other contaminants.

The example of FIG. 10 in which light guide plate fence portion 78T extends along all four sides of optical films 70 is merely illustrative. In general, light guide plate fence portion 78T may extend along one side of optical films 70, along two sides of optical films 70, along three sides of optical films 70, or along four sides of optical films 70 (if desired).

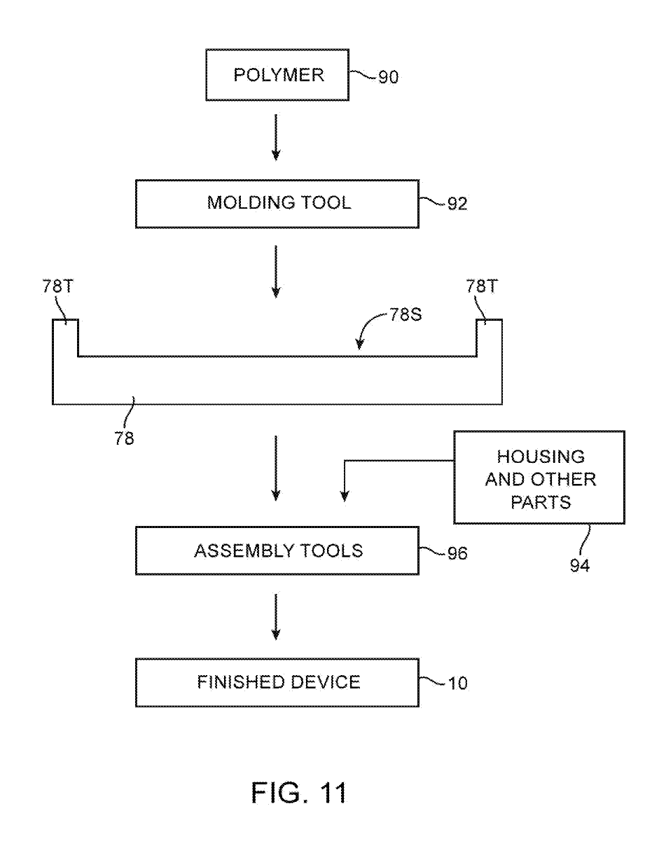

Illustrative equipment for forming a polymer light guide plate having alignment structures that are configured to laterally align an optical film stack is shown in FIG. 11. As shown in FIG. 11, equipment such as molding tool 92 receives polymer material 90 (e.g., a clear resin such as polymethyl methacrylate resin or other acrylic resin, a polycarbonate resin, etc.). Molding tool 92 may, for example, include an injection molding tool that injects polymer 90 in the form of molten plastic into a mold cavity.

Molding tool 92 molds polymer 90 into a substrate such as planar substrate 78 having alignment structures such as light guide plate alignment structures 78T. Light guide plate alignment structures 78T are integrally molded at the edges of light guide plate 78 and protrude outward from planar surface 78S of light guide plate 78 (e.g., alignment structures 78T are perpendicular to planar surface 78S of light guide plate 78).

Following formation of light guide plate 78 having alignment structures 78T, light guide plate 78, other layers of display 14, housing 12, and other parts in electronic device 10 (shown as parts 94 of FIG. 11) are assembled using assembly equipment 96, thereby forming finished electronic device 10. This may include, for example, placing optical films 70 (FIG. 6) on surface 78S of light guide plate 78 such that light guide plate alignment structures 78T are aligned with optical film alignment features 70P of optical films 70. For example, alignment structures 78T may be inserted into notches 70P of FIG. 7 or into holes 70P of FIGS. 8 and 9. Mating alignment structures 78T of light guide plate 78 with openings 70P of optical films 70 may ensure that optical films 70 are laterally aligned with respect to light guide plate 78. In the case where light guide plate alignment structures 78T are formed along the entire periphery of light guide plate 78, optical films 70 may be placed within recess 78R (FIG. 10) to laterally align optical films 70 with respect to light guide plate 78.

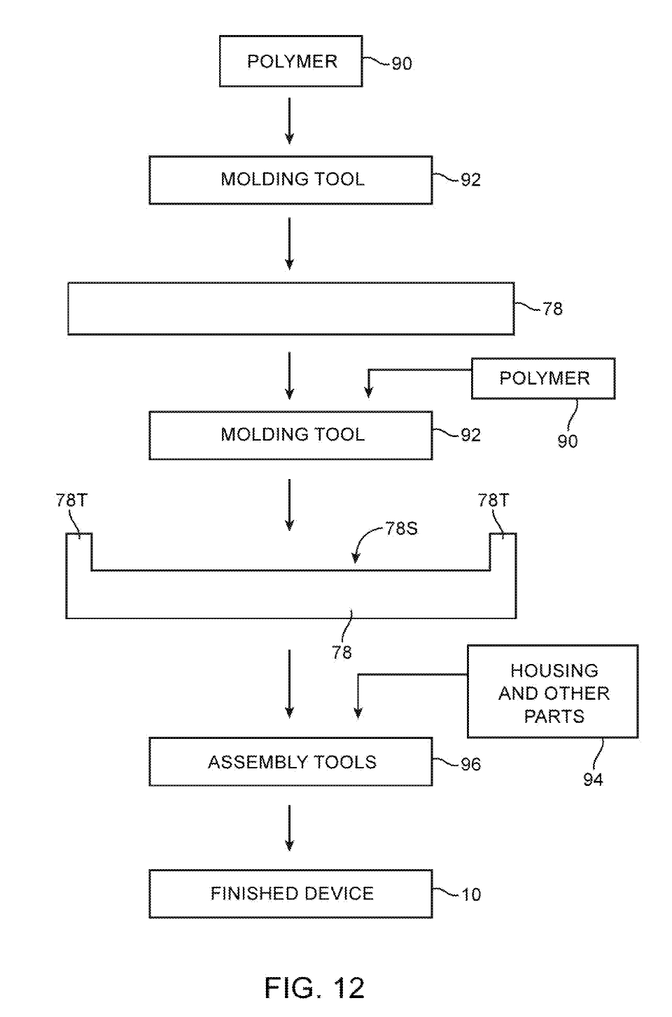

In another suitable embodiment, light guide plate 78 and light guide plate alignment structures 78T may be formed from a two-step molding process such as a two-shot injection molding process, an overmolding process, an insert molding process, or other suitable two-step molding process. Illustrative equipment for forming a polymer light guide plate having alignment structures using a two-step molding process is shown in FIG. 12. As shown in FIG. 12, equipment such as molding tool 92 receives polymer material 90 (e.g., a clear resin such as polymethyl methacrylate resin or other acrylic resin, a polycarbonate resin, etc.).

Molding tool 92 molds polymer 90 into a substrate such as planar substrate 78. This may include, for example, using an injection molding tool to inject a first shot of polymer 90 in the form of molten plastic into a mold cavity having the shape of light guide plate 78.

Following formation of light guide plate 78, molding tool 92 receives additional polymer material 90. Molding tool 92 molds additional polymer 90 onto edge portions of light guide plate 78 to form light guide plate alignment structures 78T (e.g., as part of an insert molding process or overmolding process). This may include, for example, using an injection molding tool to inject a second shot of polymer 90 into a mold cavity having the shape of light guide plate alignment structures 78T. The second shot of polymer that forms alignment structures 78T may be performed during the same molding cycle that forms light guide plate 78 or may be performed after light guide plate 78 has been molded. As shown in FIG. 12, light guide plate alignment structures 78T are molded at the edges of light guide plate 78 and protrude outward from planar surface 78S of light guide plate 78 (e.g., alignment structures 78T are perpendicular to planar surface 78S of light guide plate 78).

Following formation of light guide plate 78 having alignment structures 78T, light guide plate 78, other layers of display 14, housing 12, and other parts in electronic device 10 (shown as parts 94 of FIG. 12) are assembled using assembly equipment 96, thereby forming finished electronic device 10. This may include, for example, placing optical films 70 (FIG. 6) on surface 78S of light guide plate 78 such that light guide plate alignment structures 78T are aligned with optical film alignment features 70P of optical films 70. For example, alignment structures 78T may be inserted into notches 70P of FIG. 7 or into holes 70P of FIGS. 8 and 9. Mating alignment structures 78T of light guide plate 78 with openings 70P of optical films 70 may ensure that optical films 70 are laterally aligned with respect to light guide plate 78. In the case where light guide plate alignment structures 78T are formed along the entire periphery of light guide plate 78, optical films 70 may be placed within recess 78R (FIG. 10) to laterally align optical films 70 with respect to light guide plate 78.

The foregoing is merely illustrative and various modifications can be made by those skilled in the art without departing from the scope and spirit of the described embodiments. The foregoing embodiments may be implemented individually or in any combination.

What is claimed is:

1. A backlight assembly configured to provide backlight illumination to display layers in a display, comprising:
a light guide plate having a surface from which the backlight illumination is provided to the display layers, wherein the light guide plate has at least one light guide plate alignment feature; and
at least one optical film having an optical film alignment feature that is configured to mate with the at least one light guide plate alignment feature to laterally align the at least one optical film with respect to the light guide plate.

2. The backlight assembly defined in claim 1 wherein the at least one light guide plate alignment feature comprises a protrusion that protrudes from the surface towards the display layers.

3. The backlight assembly defined in claim 2 further comprising a stack of optical films that includes the at least one optical film, wherein each optical film in the stack of optical films includes a respective optical film alignment feature that is configured to mate with the at least one light guide plate alignment feature.

4. The backlight assembly defined in claim 2 wherein the optical film alignment feature comprises a notch in the at least one optical film that is configured to receive the protrusion in the light guide plate.

5. The backlight assembly defined in claim 2 wherein the optical film alignment feature comprises a hole in the at least one optical film that is configured to receive the protrusion in the light guide plate.

6. The backlight assembly defined in claim 2 wherein a portion of the at least one optical film partially surrounds a perimeter of the protrusion in the light guide plate.

7. The backlight assembly defined in claim 2 wherein a portion of the at least one optical film completely surrounds a perimeter of the protrusion in the light guide plate.

8. The backlight assembly defined in claim 1 wherein the light guide plate comprises polymethyl methacrylate.

9. The backlight assembly defined in claim 1 wherein the at least one optical film comprises a brightness enhancement film.

10. The backlight assembly defined in claim 1 wherein the at least one optical film has a first coefficient of thermal expansion, wherein the light guide plate has a second coefficient of thermal expansion, and wherein the first coefficient of thermal expansion is less than the second coefficient of thermal expansion.

11. A display, comprising:
display layers configured to display an image;
a light guide plate having a surface from which backlight illumination is provided to the display layers, wherein the light guide plate comprises a protruding portion that protrudes out from the surface towards the display layers and that extends along a periphery of the light guide plate; and
at least one optical film interposed between the light guide plate and the display layers, wherein the protruding portion surrounds a perimeter of the at least one optical film.

12. The display defined in claim 11 wherein the surface and the protruding portion of the light guide plate together define a recess and wherein the at least one optical film is mounted within the recess.

13. The display defined in claim 11 wherein the protruding portion comprises a rectangular fence that surrounds the perimeter of the at least one optical film and wherein the rectangular fence is configured to laterally align the at least one optical film with respect to the light guide plate.

14. The display defined in claim 11 wherein the at least one optical film has a first coefficient of thermal expansion, wherein the light guide plate has a second coefficient of thermal expansion, and wherein the first coefficient of thermal expansion is less than the second coefficient of thermal expansion.

15. The display defined in claim 11 wherein the at least one optical film comprises a diffuser layer.

16. The display defined in claim 11 wherein the display layers comprise:
a color filter layer;
a thin-film transistor layer; and
a liquid crystal layer interposed between the color filter layer and the thin-film transistor layer.

17. An electronic device, comprising:
an electronic device housing;
display layers mounted in the electronic device housing;
a light guide plate having a surface from which backlight illumination is provided to the display layers, wherein the light guide plate comprises at least one alignment feature that protrudes from the surface towards the display layers; and
a stack of optical films interposed between the display layers and the light guide plate, wherein the stack of optical films comprises at least one light guide plate receiving portion configured to mate with the at least one alignment feature to laterally align the stack of optical films with respect to the light guide plate.

18. The electronic device defined in claim 17 wherein the at least one light guide plate receiving portion comprises a first notch formed at an edge of the stack of optical films and a second notch formed at an opposing edge of the stack of optical films.

19. The electronic device defined in claim 18 wherein the at least one alignment feature comprises first and second protruding structures, wherein the first notch receives the first protruding structure, and wherein the second notch receives the second protruding structure.

20. The electronic device defined in claim 17 wherein the at least one alignment feature comprises an insert molded alignment structure that is insert molded over the light guide plate.

21. The electronic device defined in claim 17 wherein a portion of the stack of optical films partially surrounds a perimeter of the at least one alignment feature.

22. The electronic device defined in claim 17 wherein a portion of the stack of optical films completely surrounds a perimeter of the at least one alignment feature.
